(19) United States
(12) Patent Application Publication
(10) Pub. No.: US 2012/0161669 A1
(43) Pub. Date: Jun. 28, 2012

(54) FLAG SUPPORT ASSEMBLIES FOR MOTOR VEHICLES

(76) Inventors: Joshua A. Lorentz, Cincinnati, OH (US); Geoffrey L. Oberhaus, Mason, OH (US)

(21) Appl. No.: 12/975,512

(22) Filed: Dec. 22, 2010

(51) Int. Cl. H05B 37/00; F21L 4/00

(52) U.S. Cl. 315/312; 362/191; 362/183

(57) ABSTRACT

A flag support assembly for a vehicle, the flag support assembly includes a base attaching the flag support assembly to the vehicle and a stanchion comprising a first end and a second end, wherein the second end of the stanchion is attached to the base. An illumination source is at least partially positioned in the stanchion, wherein the illumination source is oriented to direct a divergent light beam substantially upwards and away from the base. An illumination circuit is electrically coupled to the illumination source and provides power to the illumination source.

### TECHNICAL FIELD

The present specification generally relates to flag support assemblies for motor vehicles and, more specifically, to flag support assemblies for motor vehicles with illuminated flags.

### BACKGROUND

Flag assemblies may be attached to a vehicle for various purposes. For example, a flag assembly may be attached to a vehicle for purposes of advertising and/or identification, such as when a flag is utilized on a commercial vehicle to display a company logo or other identifying insignia. Alternatively, a flag assembly may be displayed on a vehicle to demonstrate support for a specific organization or entity, such as when a flag is utilized to display the logo, mascot or insignia of a sports team.

While the logos, insignias, etc., displayed on such flags are readily visible in daylight, they may be difficult to see in the dark, particularly when no overhead lighting (such as street lights or the like) is present. Accordingly, a need exists for alternative flag assemblies for illuminating flag elements attached to the flag assemblies.

### SUMMARY

In one embodiment, a flag support assembly for a vehicle includes a base, a stanchion, an illumination source and an illumination circuit. The base attaches the flag support assembly to a vehicle. The stanchion includes a first end, a second end, and a cavity positioned between the first end and the second end. The second end of the stanchion is attached to the base. The illumination source may be at least partially positioned in the cavity of the stanchion. The illumination source may be oriented such that, when a flag element is positioned on the stanchion, the illumination source illuminates at least a flexible flag portion of the flag element. The illumination circuit is electrically coupled to the illumination source such that the illumination circuit provides power to the illumination source.

In another embodiment, a flag support assembly for a vehicle includes a base, a stanchion, a flag element, and an illumination circuit. The base of the flag support assembly attaches the flag support assembly to the vehicle. The stanchion includes a first end and a second end, wherein the second end of the stanchion is attached to the base. The flag element may be formed from a flexible material and is attached to the stanchion proximate the second end of the stanchion. The flag element may also include an array of discrete illumination elements arranged on a field of the flag element. The illumination circuit may be electrically coupled to the array of discrete illumination elements and includes a microcontroller electrically coupled to a memory storing at least one illumination sequence embodied in a computer readable instruction set. The microcontroller executes the computer readable instruction set to separately illuminate or extinguish individual elements of the array of discrete illumination elements according to the at least one illumination sequence to produce at least one image on the field of the flag.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a cross section of one embodiment of a flag support assembly for a vehicle according to one or more embodiments shown and described herein;

FIG. 2 schematically depicts a cross section of another embodiment of a flag support assembly for a vehicle according to one or more embodiments shown and described herein;

FIG. 3 schematically depicts a block diagram indicating the interconnectivity of various electronic components of a flag support assembly according to one or more embodiments shown and described herein;

FIG. 4 schematically depicts another embodiment of a flag support assembly according to one or more embodiments shown and described herein;

FIG. 5A schematically depicts another embodiment of a flag support assembly according to one or more embodiments shown and described herein;

FIG. 5B schematically depicts a magnified view of a portion of the flag support assembly of FIG. 5A;

FIG. 6 schematically depicts a block diagram indicating the interconnectivity of various electronic components of a flag support assembly according to one or more embodiments shown and described herein; and

FIGS. 7A-7C schematically depict different embodiments of matrices of discrete illumination elements, according to one or more embodiments shown and described herein.

### DETAILED DESCRIPTION

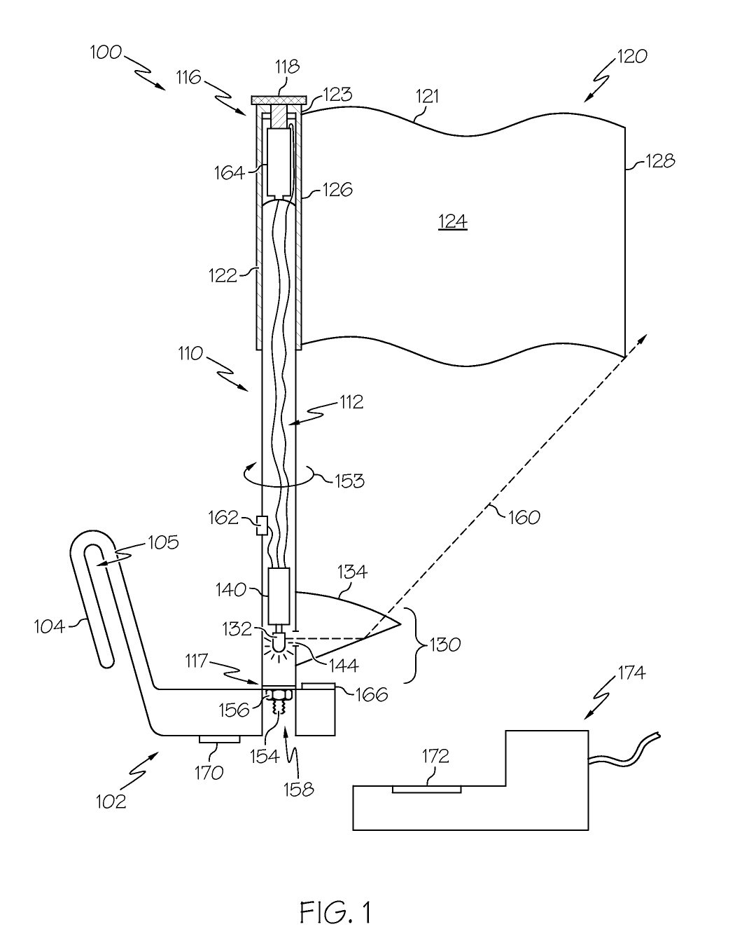

FIG. 1 generally depicts one embodiment of a flag support assembly for a vehicle. In this embodiment, the flag support assembly generally comprises a base and a stanchion attached to the base. An illumination source may be at least partially positioned in the stanchion and electrically coupled to an illumination circuit which provides power to the illumination source. The illumination source is oriented to direct a divergent light beam upward, away from the base, in order to fully illuminate a flag element attached to the stanchion. Various embodiments of flag support assemblies will be described in more detail herein.

Referring now to FIG. 1, a flag support assembly 100 is schematically depicted. The flag support assembly 100 generally comprises a base 102, a stanchion 110, an illumination source 130 and an illumination circuit 140. In some embodiments, the flag support assembly 100 further comprises a flag element 120 which is removably positioned on the stanchion 110. In the embodiments described herein, the base 102 is constructed from a polymeric material such as polypropylene, nylon, polyvinyl chloride or a similar polymeric material. However, it should be understood that, in alternative embodiments, the base may be constructed from a variety of other materials including, without limitation, metals and/or composite materials.

In the embodiments described herein, the base 102 facilitates attachment of the flag support assembly to a motor vehicle (not shown). For example, the base 102 may be integrally formed with a clip 104 which defines a receiving space 105 for receiving a portion of a vehicle window (not shown), thereby facilitating attachment of the base 102 to the vehicle. In other embodiments (not shown), the base 102 may comprise one or more magnets such that the base 102 may be magnetically attached to a body panel of a vehicle. In still other embodiments (not shown), the base 102 includes one or more suction cups which facilitate attaching the base 102 to a window and/or a body panel of the vehicle.

Still referring to FIG. 1, the stanchion 110 may be formed from a variety of different materials, including, without limitation, metals, polymers and composite materials. In the embodiments described herein, the stanchion 110 is formed from a polymeric material, such as polypropylene, nylon, polyvinyl chloride, or a similar polymeric material, and is generally circular in cross section with a first end 116 and a second end 117. The second end 117 of the stanchion 110 is attached to the base 102. For example, in the embodiment shown in FIG. 1, the second end 117 of the stanchion 110 is formed with a threaded post 154. The threaded post 154 is positioned in a corresponding mounting hole 158 formed in the base 102. The threaded post 154 is secured in the mounting hole 158 with a nut 156 threaded on to the threaded post 154. In one embodiment, the stanchion 110 is rotatable on the base 102 when the threaded post 154 is secured with the nut 156, as indicated by arrow 153. In another embodiment, the stanchion 110 is fixed relative to the base 102 when the threaded post 154 is secured with the nut 156.

While FIG. 1 depicts the stanchion 110 secured on the base 102 with a threaded post 154 and a nut 156, it should be understood that other configurations may be utilized to secure the stanchion 110 in the base 102. For example, in one embodiment (not shown), the base 102 may be formed with a thread bore, such as a threaded blind bore, and the stanchion 110 may be secured in the base 102 by threading the threaded post in to the threaded blind bore. Accordingly, it should be understood that other devices, methods and/or systems for securing the stanchion to the base are contemplated.

The stanchion 110 is formed with an internal cavity 112 in which the illumination circuit 140 and light source 132 are positioned, as will be described in more detail herein. The stanchion 110 also includes one or more apertures 114 (one shown in FIG. 1) which permit light from the light source 132 to exit the cavity 112. The cavity 112 is closed at the first end 116 with an end cap 118 which is removably secured in the first end 116. For example, in one embodiment, the end cap 118 is threadably secured in the first end 116 of the stanchion 110. In other embodiments (not shown), the end cap 118 may be inserted into the stanchion and secured with an interference fit between the stanchion 110 and the end cap 118.

While the stanchion 110 has been described herein as being generally circular in cross section, it should be understood that other configurations are possible. For example, the stanchion may alternatively be square, rectangular, octagonal, or oval in cross section or any other suitable cross-sectional geometry.

Still referring to FIG. 1, the flag support assembly 100 may optionally include a flag element 120 which is removably attached to the stanchion proximate the first end 116. The flag element 120 generally includes a flexible flag portion 121 extending between a first edge 126 and a second edge 128 which define a field 124 on which one or more logos, insignia or the like may be applied. In one embodiment, the first edge 126 of the flexible flag portion 121 is coupled to a sleeve 122 which is slidably received on the stanchion 110. The sleeve 122 is formed with a mounting collar 123 such that, when the sleeve 122 is positioned on the stanchion 110, the mounting collar 123 positions the sleeve 122 on the stanchion relative to the first end 116 of the stanchion 110 and the end cap 118 of the stanchion 110 is insertable through the mounting collar 123 and into the first end 116 of the stanchion 110 thereby securing the sleeve 122 (and the flag element 120) on the stanchion 110. In one embodiment, the sleeve 122 is non-rotatable on the stanchion 110 when the end cap 118 is attached to the stanchion 110. In another embodiment, the sleeve 122 is rotatable on the stanchion 110 when the end cap 118 is attached to the stanchion 110.

While the flag element 120 has been described herein as comprising a sleeve 122 to which the flexible flag portion 121 is attached, it should be understood that, in other embodiments, the flag element 120 is formed without a separate sleeve 122. For example, in one embodiment (not shown) the flexible material from which the flexible flag portion 121 is constructed may be formed into a sleeve proximate the first edge 126 of the flexible flag portion 121. Accordingly, it should be understood that, at least in one embodiment, the flexible flag portion 121 is integrally formed with a sleeve to facilitate attaching the flexible flag portion 121 to the stanchion.

In the embodiments described herein, the flexible flag portion 121 is formed from a fabric, such as a fabric woven from natural and/or synthetic fibers, including, without limitation, cotton, nylon, polyesters or various combinations thereof. Alternatively, the flexible flag portion may be formed from one or more sheets of polymeric material such as, for example, polyethylene films or the like. In one embodiment, the flexible flag portion 121 may be formed from, or otherwise incorporate, a photo-voltaic material such that the flexible flag portion 121 is capable of converting solar energy to electrical energy. For example, in one embodiment, the flexible flag portion may include one or more flexible photo-voltaic cells, such as the Konarka Power Plastic® Series 20 or Series 40 photo-voltaic cells manufactured by Konarka Technologies, Inc. of Lowell, Mass., which are stitched or otherwise adhered to the flexible flag portion 121. Alternatively, the flexible flag portion 121 may be formed from fibers or metallic wires coated with photo-voltaic materials.

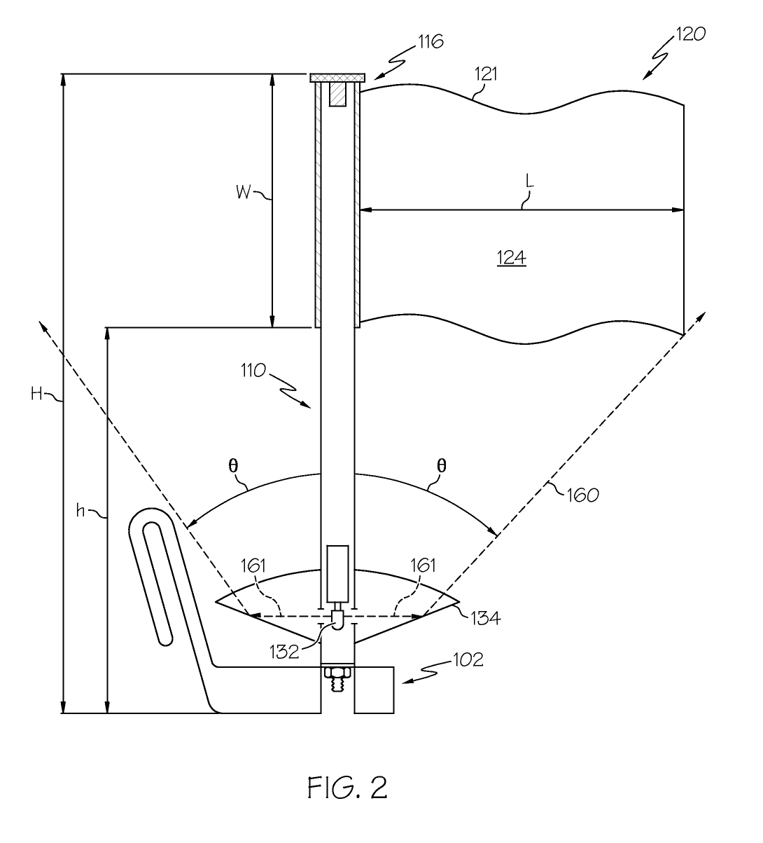

Still referring to FIG. 1, the flag support assembly 100 further comprises an illumination source 130 at least partially positioned in the stanchion 110. The illumination source 130 is oriented to direct a divergent light beam 160 substantially upwards and away from the base 102. For example, in the embodiments described herein, the illumination source comprises at least one light source 132 and a reflector 134. The reflector 134 is positioned on the stanchion 110 proximate the second end 117 of the stanchion 110. In the embodiments described herein, the reflector 134 is substantially conical such that the reflector 134 redirects light emitted from the apertures 114 in the stanchion 110 in a radial direction into a divergent light beam 160 that is directed upwards, away from the base 102. For example, in the embodiment shown in FIG. 1, the reflector 134 comprises a portion of a cone (i.e., a half cone). However, in other embodiments, the reflector 134 may be a full cone, as shown in FIG. 2. The reflector 134 may be integrally formed with the stanchion 110 and coated or metallized with a reflective material, such as aluminum or the like. Alternatively, the reflector 134 may be attached to the stanchion 110, such as with screws or an adhesive. In the embodiments described herein the reflector may be positioned to illuminate the flag element 120 or the flag element 120 and the stanchion 110, including the portion of the stanchion where the flag element 120 is attached to the stanchion.

In embodiments where the reflector 134 is a half cone, as depicted in FIG. 1, the stanchion 110 is rotatable with respect to the base 102, and the flag element 120 is non-rotatable with respect to the stanchion 110. In this embodiment, when the stanchion 110 is rotated on the base, such as when the motion of the flag element 120 due to wind and/or the motion of a vehicle to which the flag support assembly 100 is attached causes the stanchion to rotate on the base 102, the reflector 134 and light source 132 rotate with the stanchion 110 such that the flag element is constantly illuminated regardless of its rotational orientation with respect to the base 102.

The light source 132 is positioned in the cavity 112 of the stanchion 110 such that the light source 132 emits light through the apertures 114 in the stanchion 110. In the embodiments shown and described herein the light source 132 is a light emitting diode (LED). However, it should be understood that, in other embodiments, the light source 132 may be an incandescent bulb, a fluorescent bulb, or any other suitable light source.

Referring now to FIG. 2, light 161 emitted from the light source 132 is reflected by the reflector 134 to form a divergent light beam 160 which is directed upwards, away from the base 102 and towards the flag element 120. In the embodiments described herein, the divergent light beam 160 is sufficient to illuminate the entire field 124 of the flexible flag portion 121 of the flag element 120. For example, in embodiments where the flag element 120 is attached proximate the first end 116 of the stanchion 110, the divergent light beam 160 has a divergence angle θ with respect to the stanchion 110 such that:

$$θ \geq {tan}^{- 1} ( \frac{L}{H - W} ) ,$$

where L is a maximum length of the flag element, W is a maximum width of the flag element, and H is a height of the stanchion.

While the illumination source 130 has been described herein as comprising a light source 132 and a reflector 134, which is positioned proximate the base 102 and oriented to direct a divergent light beam upwards, away from the base 102, it should be understood that, in other embodiments (not shown), the light source may be positioned at other locations within the stanchion. For example, in one embodiment (not shown), the illumination source 130, specifically the light source 132, is positioned in the cavity 112 proximate the first end 116 of the stanchion 110. In this embodiment the stanchion 110 may comprise one or more apertures which allow light from the light source 132 to be directed on to the flag element 120 thereby illuminating the flexible flag portion 121 of the flag element 120. Accordingly, it should be understood that other positions of the illumination source 130 within the cavity 112 of the stanchion 110 which facilitate illuminating the flag element 120, including the flexible flag portion 121 of the flag element, are also contemplated.

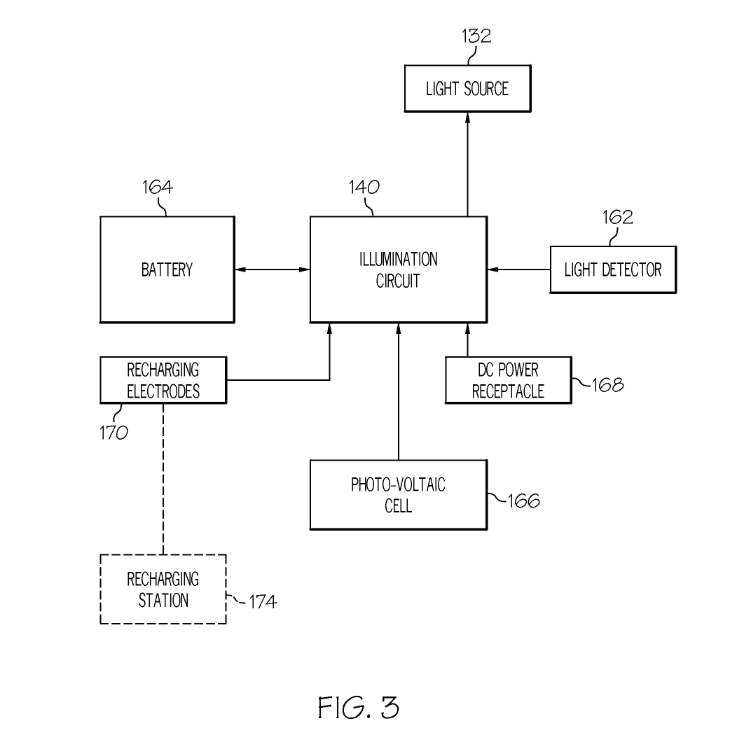

Referring now to FIGS. 1 and 3, FIG. 3 schematically depicts a block diagram of illustrating the interconnectivity of various electrical components of the flag support assembly 100. The light source 132 of the illumination source 130 is electrically coupled to an illumination circuit 140 which provides power to the light source 132. As depicted in FIG. 1, the illumination circuit 140 is positioned in the stanchion 110. However, in alternative embodiments, the illumination circuit 140 may be positioned in the base 102.

In one embodiment, one or more batteries 164 are positioned in the stanchion 110 and electrically coupled to the illumination circuit 140 thereby providing power to the illumination circuit 140 and the light source 132. In the embodiment shown in FIG. 1, the battery 164 is positioned proximate the first end 116 of the stanchion 110 such that the battery may be removed and replaced by removing the end cap 118.

In embodiments where the flag support assembly 100 comprises a battery 164, the flag support assembly 100 optionally comprises one or more photo-voltaic cells electrically coupled to the illumination circuit 140 to facilitate recharging the battery 164. For example, in one embodiment, a photo-voltaic cell 166 is positioned on the base 102 and electrically coupled to the illumination circuit 140 which, in turn, is electrically coupled to the battery 164. Solar energy incident on the photo-voltaic cell 166 is converted to electrical energy and transmitted to the illumination circuit 140 which, in turn, charges the battery 164.

In another embodiment, the flexible flag portion 121 may be constructed with one or more photo-voltaic cells and/or from photo-voltaic fibers, as described above. In this embodiment, the photo-voltaic cells and/or photo-voltaic fibers are electrically coupled to the illumination circuit 140. Solar energy incident on the flexible flag portion 121 is converted to electrical energy by the photo-voltaic cells and/or photo-voltaic fibers and transmitted to the illumination circuit 140. The illumination circuit 140 utilizes the electrical energy to recharge the battery 164.

In some embodiments, the flag support assembly 100 optionally comprises a DC power receptacle in which a DC power adapter may be removably inserted. The illumination circuit 140 is coupled to the DC power receptacle 168. In these embodiments, the DC power adapter is used to power the illumination circuit 140 and the illumination source 130. In embodiments where the flag support assembly 100 also includes a battery 164, the DC power adapter may be utilized to recharge the battery 164.

The flag support assembly 100 may optionally comprise one or more recharging electrodes 170. The recharging electrodes 170 are positioned on the base 102 and electrically coupled to the illumination circuit 140. The base 102 may be inserted into a charging station 174 such that the recharging electrodes 170 are mated with corresponding electrodes 172 in the charging station 174. The charging station 174 provides the illumination circuit 140 with electrical energy through the recharging electrodes 170 which the illumination circuit utilizes to recharge the battery 164. In the embodiment of the charging station 174 depicted in FIG. 1, the charging station 174 is configured to receive a single flag support assembly. However, in other embodiments (not shown), the charging station 174 may be configured to receive multiple flag support assemblies such that multiple flag support assemblies may be charged simultaneously.

Still referring to FIG. 3, the flag support assembly 100 may optionally include a light detector 162. The light detector 162 is electrically coupled to the illumination circuit 140 such that an electrical signal is propagated from the light detector 162 to the illumination circuit 140. The electrical signal propagated from the light detector 162 is indicative of the environmental lighting conditions in which the flag support assembly 100 is positioned. In this embodiment, the illumination circuit 140 is operable to switch on the light source 132 of the illumination source 130 thereby illuminating the flag element 120 when the electrical signal propagated from the light detector 162 is below a predetermined threshold level, thus indicating low levels of ambient light.

The embodiment of the flag support assembly 100 depicted in FIG. 1 facilitates illuminating a flag element attached to the flag support assembly such that the flag element, and any insignia positioned on the flag element are visible in low light conditions. Further, the embodiments of the flag support assembly shown in FIGS. 1-3 permit a battery powering the illumination source of the flag support assembly to be readily recharged either using a separate base station and/or one or more photo-voltaic cells or photo-voltaic fibers electrically coupled to the battery through the illumination circuit.

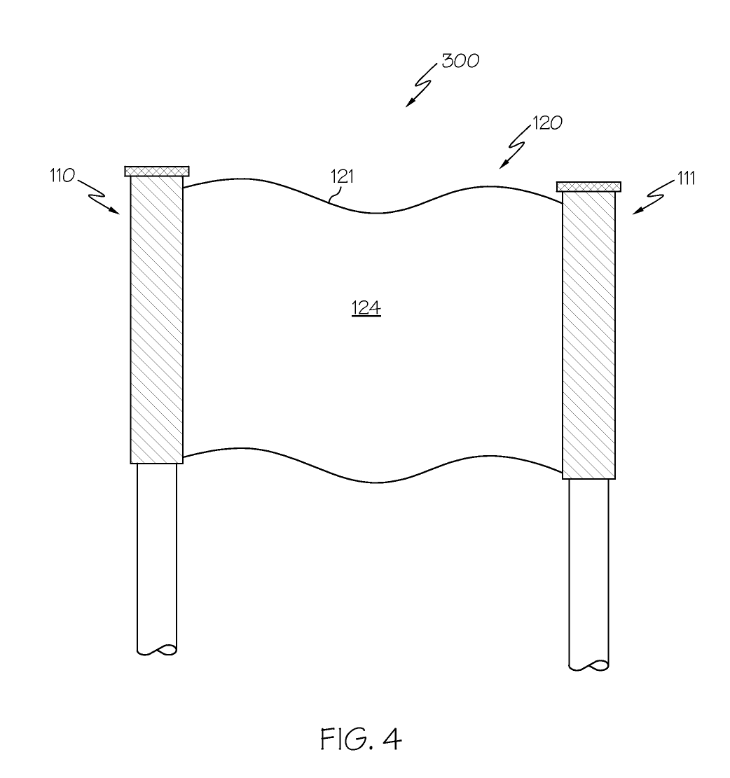

Referring now to FIG. 4, an alternative embodiment of a flag support assembly 300 is schematically depicted. In this embodiment, the flag support assembly 300 further comprises an additional stanchion 111 and the flag element 120 is affixed to both the stanchion 110 and the additional stanchion 111 such that the flexible flag portion 121 extends between the stanchion 110 and the additional stanchion 111. In one embodiment, the additional stanchion 111 may include an additional illumination source (not shown), for illuminating the flag element. Alternatively, the additional stanchion 111 may contain control electronics and/or circuitry for powering an array of discrete illumination elements of the flag element 120 (described in more detail herein).

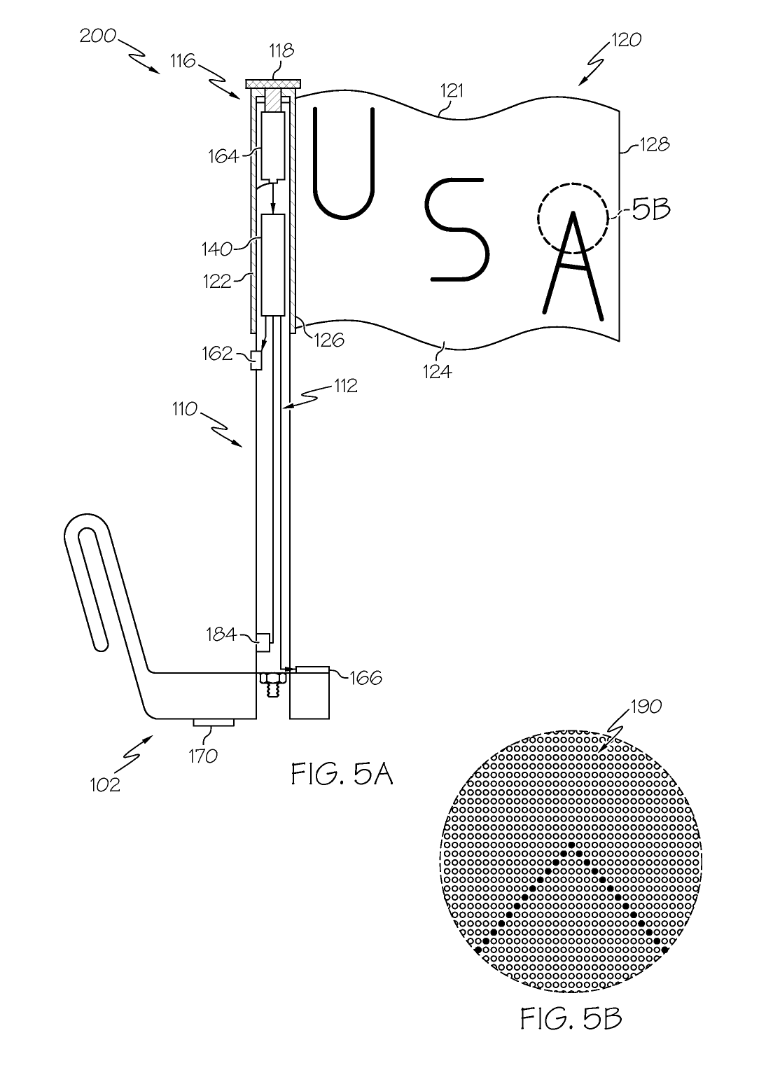

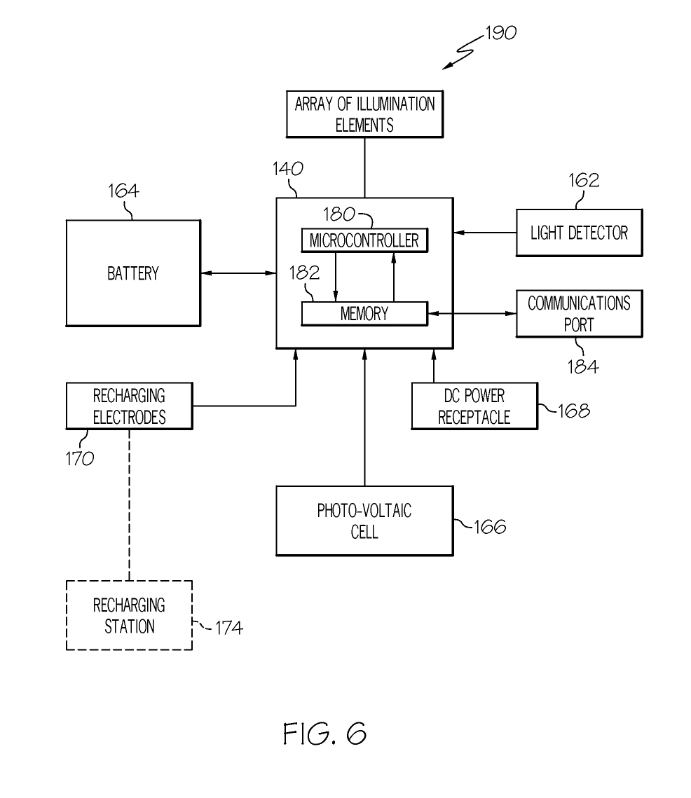

Referring now to FIGS. 5A-5B and 6, another embodiment of a flag support assembly 200 is depicted in FIGS. 5A-5B and a block diagram depicting the interconnectivity of various electrical components of the flag support assembly 200 is schematically depicted in FIG. 6. In this embodiment, the flag support assembly 200 comprises a base 102 with a stanchion 110 coupled to the base 102, as described above with respect to FIGS. 1 and 2. The flag support assembly 200 also includes a flag element 120 which is coupled to the stanchion 110 as described hereinabove. The flag element 120 generally includes a flexible flag portion 121 extending between a first edge 126 and a second edge 128 which define a field 124 on which one or more logos, insignia or the like (not shown) may be applied. In the embodiments described herein, the flexible flag portion 121 is formed from a fabric, such as a fabric woven from natural and/or synthetic fibers, including, without limitation, cotton, nylon, polyesters or various combinations thereof. Alternatively, the flexible flag portion may be formed from one or more sheets of polymeric material such as, for example, polyethylene films or the like. One or more insignia or other identifying indicia may be attached to or otherwise incorporated on the field of the flexible flag portion 121.

As shown in FIG. 5B, the flexible flag portion 121 includes an array of discrete illumination elements 190 which are affixed to or integrally formed with the field 124 of the flexible flag portion 121. As will be described in more detail herein, the array of discrete illumination elements is electrically coupled to the illumination circuit 140 which is programmed to illuminate or extinguish individual elements of the discrete illumination elements of the array according to a pre-determined illumination sequence such that an image is displayed on the field 124 of the flexible flag portion 121.

More specifically, the illumination circuit 140 of the flag support assembly 200 includes a memory 182 which stores at least one illumination sequence embodied in a computer readable instruction set. The memory 182 is communicatively coupled to a microcontroller 180 which, in turn, is electrically coupled to the array of discrete illumination elements 190. The microcontroller 180 is operable to execute the computer readable instruction set to separately illuminate or extinguish individual elements of the array of discrete illumination elements according to the at least one illumination sequence to produce at least one image on the field 124 of the flexible flag portion 121.

In one embodiment of the flag support assembly 200, the at least one image which is illuminated on the field 124 of the flexible flag portion 121 is a sequence of images. Accordingly, in this embodiment, it should be understood that the illumination sequence is streaming such that illumination sequence produces a sequence of images rather than a single fixed, static image. In another embodiment, the memory 182 may comprise multiple illumination sequences. For example, the at least one illumination sequence may include a first illumination sequence and a second illumination sequence. In this embodiment, the microcontroller can be programmed to illuminate the illumination elements according to the first illumination sequence, the second illumination sequence or both the first and the second illumination sequence, such as when the array of discrete illumination elements are consecutively illuminated according to the first illumination sequence and the second illumination sequence.

For example, referring to FIGS. 5A and 5B, individual elements of the array of discrete illumination elements 190 are illuminated to represent the characters “U”, “S”, and “A” on the field 124 of the flexible flag portion 121. However, the illumination sequence stored in the memory 182 of the illumination circuit may contain instructions to illuminate these characters sequentially. For example, individual elements of the array of discrete illumination elements 190 may be illuminated to display the “U” character on the field 124 and then extinguished. Thereafter, individual elements of the array of discrete illumination elements 190 may be illuminated to display the “S” character on the field 124 and then extinguished. Finally, individual elements of the array of discrete illumination elements 190 may be illuminated to display the “A” character on the field 124 and then extinguished. Accordingly, it should be understood that a single illumination sequence may be executed to produce a single static image or, alternatively, a sequence of static images. Accordingly, it should also be understood that individual elements of the array of discrete illumination elements 190 can be illuminated and/or extinguished with the microcontroller 180 to display a sequence of static images rather than a single static image.

In the embodiment of the flag support assembly 200 described herein, the memory 182 of the illumination circuit is communicatively coupled to a communications port 184, such as universal serial bus (USB) port or the like, in order to facilitate downloading illumination sequences to the memory 182 from an external electronic storage device, such as a computer, hard disk drive, personal electronic device (i.e., a smart phone, digital medial player or the like), or a similar external electronic storage device. Accordingly, it should be understood that the memory 182 is capable of storing multiple illumination sequences. Moreover, the communications port 184 may be utilized to download display instructions to the memory 182 which, when executed by the processor, causes the illumination patterns to be executed in a predetermined sequence or sequences as defined by the display instructions.

In one embodiment, the memory of the flag support assembly 200 is pre-programmed with a specific illumination sequence. However, it should be understood that additional or alternative illumination sequences may be uploaded to the memory of the flag support assembly. In another embodiment, the flag support assembly 200 may be produced without a specific illumination sequence stored in the memory. In this embodiment, a user of the flag support assembly 200 is able to customize the flag support assembly 200 by uploading specific illumination sequences to the memory to suit his or her needs. This embodiment may facilitate the use of the flag support assembly 200 for commercial purposes, such as advertising and/or company identification, where the illumination sequence displayed on the flag support assembly 200 may be regularly changed to reflect current promotions and the like.

Referring now to FIGS. 5A-5B, 6 and 7A, in one embodiment, the array of discrete illumination elements 190 comprises a plurality of light emitting diodes (LEDs) 191. For example, the LEDs 191 may be arranged in a matrix on the field 124 of the flexible flag portion 121. Each LED 191 is electrically coupled to the microcontroller 180 such that the microcontroller is operable to illuminate and/or extinguish individual elements of the array of discrete illumination elements according to an illumination sequence stored in the memory 182 thereby producing the desired image on the field 124 of the flexible flag portion 121.

In some embodiments, the array of discrete illumination elements may include LEDs which are the same color. In another embodiment, the array of discrete illumination elements may include LEDs of different colors. For example, the array of discrete illumination element may include an array of red LEDs, an array of blue LEDs and an array of green LEDs. In this embodiment, the red LEDs, blue LEDs and green LEDs may be individually illuminated according to the illumination sequence stored in memory to produce give the appearance of a color image. Alternatively, each of the LEDs used in the array of discrete illumination elements may be capable of emitting red, green and blue light depending on the control signal received from the microcontroller. Accordingly, it should be understood that, in some embodiments, the instruction set executed by the microcontroller to produce the illumination sequence not only controls which of the discrete illumination elements are illuminated, but also the color of the discrete illumination elements.

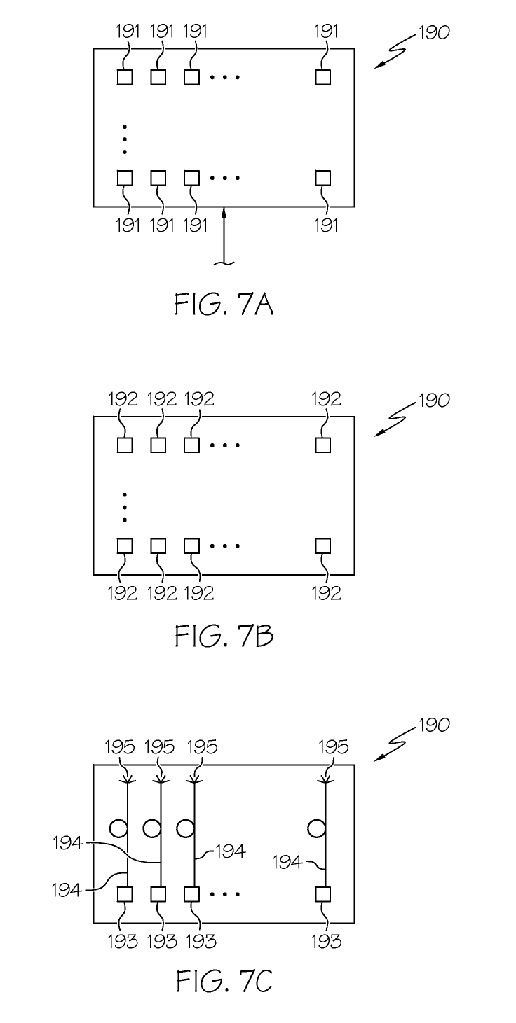

Referring to FIGS. 5A-5B, 6, and 7B in an alternative embodiment, the array of discrete illumination elements 190 includes a matrix of areas 192 coated or incorporating electroluminescent material. For example, the array of discrete illumination elements 190 may include an array of discrete areas 192 of electroluminescent material, such as electroluminescent tape or electroluminescent fabric, which is attached to or otherwise incorporated in the field 124 of the flexible flag portion 121. Alternatively, an array of electroluminescent wires may be incorporated into the field 124 of the flexible flag portion 121. The electroluminescent wires may be shielded or otherwise coated such that only a portion of the wire is visible when electroluminescent wire is illuminated. Each area 192 of electroluminescent material is electrically coupled to the microcontroller 180 such that the microcontroller is operable to illuminate and/or extinguish individual elements of the array of discrete illumination elements according to the illumination sequence stored in the memory 182 thereby producing the desired image or images on the field 124 of the flexible flag portion 121. As described hereinabove with respect to FIG. 7A, when the array of discrete illumination elements 190 are formed from electroluminescent material, electroluminescent material which emit different colors of light may be individually illuminated with the microcontroller 180 according to the illumination sequence to give the visual impression of a color image being displayed on the flexible flag portion 121 of the flag element.

Referring to FIGS. 5A-5B, 6, and 7C, in yet another embodiment, the array of discrete illumination elements 190 includes an array of optical fibers 194, such as glass optical fibers and/or polymer optical fibers, which are incorporated into the field 124 of the flexible flag portion 121. For example, the optical fibers 194 may be woven into the flexible flag portion 121 or alternatively, may be bonded to the flexible flag portion 121. In one embodiment, the flexible flag portion 121 comprises multiple plies (i.e., a front ply and a back ply) and the optical fibers 194 are incorporated between the plies. An end point 195 of each optical fiber 194 is oriented such that light propagating in the optical fiber is emitted from the field 124 of the flexible flag portion 121. Each optical fiber 194 is optically coupled to at least one light source 193, such as an LED or similar light source. The light sources 193 are electrically coupled to the microcontroller 180 which is programmed to illuminate or extinguish each light source 193 based on an illumination sequence stored in the memory 182. When a light source 193 is illuminated, the light from the light source is propagated through the optical fiber 194 to the end 195 of the optical fiber 194 where it is emitted from the field 124 of the flexible flag portion 121, thereby illuminating an individual one of the array of discrete illumination elements. By illuminating and/or extinguishing individual light sources 193 according to the illumination sequence stored in the memory 182 a desired image is illuminated on the field 124 of the flexible flag portion 121. In one embodiment, the at least one light source comprises a plurality of light sources. For example, some of the light sources may be red, green or blue LEDs. In some embodiments, each optical fiber is coupled to a different light source. The light sources may be individually illuminated and extinguished with the microcontroller according to the illumination sequence to give the visual impression of a color image being displayed on the flexible flag portion 121 of the flag element.

While FIGS. 7A-7C depict different mechanisms for producing an array of discrete illumination elements on the field 124 of the flexible flag portion 121, it should be understood that other mechanisms are possible. For example, it is contemplated that the array of discrete illumination elements may be a flexible display device, such as a flexible organic light emitting diodes (OLED), e-paper, flexible LCD displays, or similar flexible display devices. The flexible display device could be electrically coupled to the microcontroller which would illuminate the flexible display device according to the illumination patterns stored in the memory of the illumination circuit.

Moreover, it should be understood that the resolution of an image formed on the flexible flag portion 121 is dependent on the number of discrete illumination elements in the array. Accordingly, the resolution of the image may be increased by increasing the number of discrete illumination elements illuminated on the flag or decreased by decreasing the amount of discrete illumination elements illuminated on the flag.

It should also be understood that the array of discrete illumination elements may take on different configurations. For example, the array may comprise a matrix of discrete illumination element, as depicted in FIG. 5B. In alternative embodiments, the array of discrete illumination elements may be arranged in predetermined patterns such that multiple images may be provided by selectively illuminating individual elements of the array of discrete illumination elements.

Referring to FIGS. 5A and 6, FIG. 6 schematically depicts a block diagram illustrating the interconnectivity of various electrical components of the flag support assembly 200. In one embodiment, one or more batteries 164 are positioned in the stanchion 110 and electrically coupled to the illumination circuit 140 thereby providing power to the illumination circuit 140. In the embodiment shown in FIG. 2, the battery 164 is positioned proximate the first end 116 of the stanchion 110 such that the battery may be removed and replaced by removing the end cap 118.

As described hereinabove, in embodiments where the flag support assembly 200 comprises a battery 164, the flag support assembly 200 optionally comprises one or more photo-voltaic cells electrically coupled to the illumination circuit 140 to facilitate recharging the battery 164. In some embodiments, the flag support assembly 200 optionally comprises a DC power receptacle in which a DC power adapter may be removably inserted. The illumination circuit 140 is coupled to the DC power receptacle 168. In these embodiments, the DC power adapter is used to power the illumination circuit 140 and/or recharge the battery 164.

In some embodiments, the flag support assembly 200 optionally includes one or more recharging electrodes 170 and a charging station as described above. The flag support assembly 200 can be inserted in the recharging station such that the recharging electrodes 170 are mated with corresponding electrodes in the charging station thereby charging the battery 164.

The flag support assembly 200 may optionally include a light detector 162 as described hereinabove with respect to the embodiment of the flag support assembly depicted in FIG. 1. In this embodiment, the illumination circuit 140 is operable to switch on the light source 132 of the illumination source 130 thereby illuminating the flag element 120 when the electrical signal received from the light detector 162 is below a predetermined threshold level, thus indicating low levels of ambient light.

It should now be understood that the embodiments of the flag support assembly 200 shown and described herein provide a flag element which can be illuminated in low-light conditions to improve the visibility of the flag element. Moreover, the use of an array of discrete illumination elements together with the microcontroller and memory of the illumination circuit facilitate displaying multiple images and/or sequences of images on a single flag element. Moreover, the communications port coupled to the memory permits different illumination sequences and different illumination instructions to be downloaded to the memory such that the images displayed on the flag element can be readily changed and/or altered at the user's desire.

Moreover, it should be understood that the flag support assemblies described herein may be incorporated into as a system of flag support assemblies for use with commercial vehicles. For example, a plurality of flag support assemblies may be initially provided without flag elements or, where the flag element comprises an array of discrete illumination elements, without a specific illumination sequence programmed into the memory. Thereafter, a specific flag element may be attached to the flag support assemblies or the flag support assemblies may be programmed with a desired illumination sequence, such as a corporate logo or the like. The flag support assemblies may then be attached to commercial vehicles, such as fleet vehicles or the like. The flag support assemblies may be periodically recharged in a common charger (which may accommodate a plurality of individual flag support assemblies for simultaneous charging, and/or reprogrammed to display a new illumination sequence.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A flag support assembly for a vehicle, the flag support assembly comprising:
a base attaching the flag support assembly to the vehicle;
a stanchion comprising a first end, a second end, and a cavity positioned between the first end and the second end, wherein the second end of the stanchion is attached to the base;
an illumination source at least partially positioned in the cavity of the stanchion, wherein the illumination source is oriented such that, when a flag element is positioned on the stanchion, the illumination source illuminates at least a flexible flag portion of the flag element; and
an illumination circuit electrically coupled to the illumination source, the illumination circuit providing power to the illumination source.

2. The flag support assembly of claim 1, further comprising a flag element attached to the stanchion proximate the first end of the stanchion.

3. The flag support assembly of claim 2, wherein:
a first edge of the flag element is fixed to the stanchion such that the flag element is non-rotatable on the stanchion; and
the stanchion is rotatable with respect to the base.

4. The flag support assembly of claim 2, wherein:
the illumination source is oriented to direct a divergent light beam substantially upwards and away from the base; and
an angle of divergence θ of the divergent light beam relative to the stanchion is
$$\geq {tan}^{- 1} ( \frac{L}{H - W} ) ,$$
wherein L is a maximum length of the flag element, W is a maximum width of the flag element, and H is a height of the stanchion.

5. The flag support assembly of claim 2, wherein the flag element comprises photovoltaic material electrically coupled to the illumination circuit.

6. The flag support assembly of claim 2, further comprising an additional stanchion, wherein the flag element is affixed to the stanchion and the additional stanchion such that the flexible flag portion of the flag element extends between the stanchion and the additional stanchion.

7. The flag support assembly of claim 1, wherein the illumination circuit comprises a DC power receptacle for receiving a DC power adapter.

8. The flag support assembly of claim 7, further comprising a photo-voltaic cell electrically coupled to at least one battery, the photo-voltaic cell charging the at least one battery.

9. The flag support assembly of claim 1, wherein the illumination source comprises at least one light source and a reflector, wherein:
the reflector is positioned on the stanchion proximate the second end of the stanchion; and
the at least one light source is positioned to emit light onto the reflector, wherein the reflector redirects the light upwards, away from the base.

10. The flag support assembly of claim 1, wherein:
the base comprises recharging electrodes electrically coupled to the illumination circuit; and
the base is insertable into a charging station such that the recharging electrodes are electrically coupled to corresponding electrodes of the charging station.

11. A flag support assembly for a vehicle, the flag support assembly comprising:
a base attaching the flag support assembly to the vehicle;
a stanchion comprising a first end and a second end, wherein the second end of the stanchion is attached to the base;
a flag element formed from a flexible material attached to the stanchion proximate the second end of the stanchion, wherein the flag element comprises an array of discrete illumination elements arranged on a field of the flag element; and
an illumination circuit electrically coupled to the array of discrete illumination elements, the illumination circuit comprising a microcontroller electrically coupled to a memory storing at least one illumination sequence embodied in a computer readable instruction set, wherein the microcontroller executes the computer readable instruction set to separately illuminate or extinguish individual elements of the array of discrete illumination elements according to the at least one illumination sequence to produce one or more images on the field of the flag element.

12. The flag support assembly of claim 11, further comprising an additional stanchion, wherein the flag element is affixed to the stanchion and the additional stanchion such that a flexible flag portion of the flag element extends between the stanchion and the additional stanchion.

13. The flag support assembly of claim 11, wherein the one or more images is a sequence of images.

14. The flag support assembly of claim 11, wherein:
the at least one illumination sequence comprises a first illumination sequence and a second illumination sequence; and
the microcontroller illuminates the array of discrete illumination elements according to at least one of the first illumination sequence and the second illumination sequence.

15. The flag support assembly of claim 11, wherein the array of discrete illumination elements are light emitting diodes.

16. The flag support assembly of claim 11, wherein the array of discrete illumination elements comprise:
a plurality of optical fiber elements positioned in the flag element and optically coupled to at least one light source, wherein light from the at least one light source is propagated through the plurality of optical fiber elements which emit visible light from the flag element; and
the microcontroller is electrically coupled to the at least one light source, the microcontroller controlling when the at least one light source is illuminated or extinguished according to the at least one illumination sequence.

17. The flag support assembly of claim 16, wherein:
the at least one light source comprises a plurality of light sources; and
individual elements of the plurality of optical fiber elements are coupled to at least one of the plurality of light sources.

18. The flag support assembly of claim 11, further comprising a communications port communicatively coupled to the memory, wherein the communications port facilitates downloading and storing the at least one illumination sequence to the memory.

19. The flag support assembly of claim 11, wherein:
the array of discrete illumination elements are electroluminescent elements; and
the electroluminescent elements are individually electrically coupled to the microcontroller, the microcontroller controlling an illumination of the electroluminescent elements according to the at least one illumination sequence.

20. The flag support assembly of claim 11, wherein:
the illumination circuit is electrically coupled to at least one battery; and
the flag element further comprises photovoltaic material electrically coupled to the at least one battery, the photovoltaic material recharging the at least one battery.
